(19) United States
(12) Patent Application Publication
(10) Pub. No.: US 2024/0288806 A1
(43) Pub. Date: Aug. 29, 2024

(54) IMAGE FORMING APPARATUS THAT SUPPRESSES EXCESSIVE TEMPERATURE INCREASE OF HEATER, DEPENDING ON WHETHER DUTY RATIO FOR CONTROLLING POWER SUPPLY TO SUB HEATER IS APPROPRIATE

(71) Applicant: KYOCERA Document Solutions Inc., Osaka (JP)

(72) Inventors: Yuto MASAOKA, Osaka (JP); Yuta KITABAYASHI, Osaka (JP); Ryohei TOKUNAGA, Osaka (JP); Akihiro KONDO, Osaka (JP); Rina KIKUGAWA, Osaka (JP); Hiroki KAWASAKI, Osaka (JP); Shunsaku FUJII, Osaka (JP)

(73) Assignee: KYOCERA Document Solutions Inc., Osaka (JP)

(21) Appl. No.: 18/587,012

(22) Filed: Feb. 26, 2024

(30) Foreign Application Priority Data
Feb. 28, 2023 (JP) 2023-029706

(51) Int. Cl. G03G 15/20; G03G 15/00

(52) U.S. Cl. CPC G03G 15/2039; G03G 15/2053; G03G 15/2064; G03G 15/5004

(57) ABSTRACT

An image forming apparatus includes an image forming device, a fixing belt, a heater including a main heater and two sub heaters, a pressure member, a drive device, a main temperature sensor that detects a temperature of the main heater, a sub temperature sensor that detects a temperature of only one of the two sub heaters, a controller, and an abnormality decision device that decides whether a duty ratio adopted by the controller, to control the power amount to be supplied to the two sub heaters, is an appropriate value corresponding to a transport status of the recording medium in a regular transport mode. The controller executes, when the abnormality decision device decides that the duty ratio adopted to control the power amount to be supplied to the two sub heaters is not the appropriate value, a predetermined preventive operation for suppressing an excessive temperature increase of the heater.

### INCORPORATION BY REFERENCE

This application claims priority to Japanese Patent Application No.2023-029706 filed on Feb. 28, 2023, the entire contents of which are incorporated by reference herein.

### BACKGROUND

The present disclosure relates to a fixing device that fixes, by thermocompression, an image formed on a recording medium such as a recording sheet, and an image forming apparatus including the fixing device.

Existing image forming apparatuses that utilize the electrophotography process, such as a copier or a multifunction peripheral, include a fixing device that fixes the image formed on the recording medium. Some fixing devices include a rotatable cylindrical fixing belt, a heater that heats the fixing belt, a heater retention member that holds the heater so as to bring the heater into contact with the inner circumferential surface of the fixing belt, and a pressure member that holds the fixing belt between itself and the heater, and defines a nip region between itself and the fixing belt, through which the recording medium is transported in a nipped state, the pressure member being configured to drive the fixing belt to rotate. With such a configuration, the image formed on the recording medium is fixed thereto, by being heated and pressed (thermocompression) in the nip region. In addition, the fixing device includes a temperature sensor that detects the temperature of the heater, to maintain the temperature of the fixing belt that holds and heats the recording medium, at an appropriate level.

### SUMMARY

The disclosure proposes further improvement of the foregoing techniques.

In an aspect, the disclosure provides an image forming apparatus including an image forming device, a fixing belt, a heater, a pressure member, and a drive device. The image forming device forms an image on a recording medium. The fixing belt has a cylindrical shape, and is rotatable. The heater heats the fixing belt. The pressure member holds the fixing belt between the pressure member and the heater, thereby defining a nip region, through which the recording medium having the image formed thereon by the image forming device is transported in a nipped state, between the pressure member and the fixing belt, and drives the fixing belt to rotate. The drive device activates the heater. The heater includes a main heater located at a central portion of the fixing belt in a rotation axis direction, and two sub heaters located at respective end portions. The image forming apparatus further includes a main temperature sensor, a sub temperature sensor, and a control device. The main temperature sensor detects a temperature of the main heater. The sub temperature sensor detects a temperature of only one of the two sub heaters. The control device includes a processor, and acts as a controller and an abnormality decision device, when the processor executes a control program. The controller determines an amount of power to be supplied to the main heater on a basis of the temperature detected by the main temperature sensor, and supplies the power to the main heater through the drive device, at a duty ratio corresponding to the power amount determined. The controller also determines an amount of power to be supplied to the two sub heaters on a basis of the temperature detected by the sub temperature sensor, and supplies the power to the two sub heaters through the drive device, at a duty ratio corresponding to the power amount determined. The abnormality decision device decides whether the duty ratio adopted by the controller, to control the amount of power to be supplied to the two sub heaters, accords with a first appropriate value corresponding to a transport status of the recording medium in a regular transport mode. The controller executes, when the abnormality decision device decides that the duty ratio adopted to control the amount of power to be supplied to the two sub heaters discords with the first appropriate value, a predetermined preventive operation for suppressing an excessive temperature increase of the heater.

### BRIEF DESCRIPTION OF THE DRAWINGS

FIG. 1 is a functional block diagram schematically showing an essential internal configuration of an image forming apparatus according to an embodiment of the disclosure;

FIG. 2 is a perspective view showing an example of a fixing device included in the image forming apparatus;

FIG. 3 is a cross-sectional view schematically showing the example of the fixing device;

FIG. 4 is a bottom view schematically showing an example of wiring in a heater of the fixing device;

FIG. 5A is a schematic drawing showing a recording sheet being transported through a correct position in a regular transport mode;

FIG. 5B is a schematic drawing showing the recording sheet shifted to one side;

FIG. 6A is a graph showing an example of a change over time of a duty ratio, realized when power is supplied to the heater;

FIG. 6B is a schematic diagram showing images of temperature distribution of the heater;

FIG. 7A is a graph showing another example of the change over time of the duty ratio, realized when power is supplied to the heater;

FIG. 7B is a schematic diagram showing other images of the temperature distribution of the heater;

FIG. 8A is a graph showing still another example of the change over time of the duty ratio, realized when power is supplied to the heater;

FIG. 8B is a schematic diagram showing other images of the temperature distribution of the heater;

FIG. 9 is a flowchart showing an example of a temperature controlling operation for the fixing device, performed by the image forming apparatus; and

FIG. 10 is a graph showing still another example of the change over time of the duty ratio, realized when power is supplied to the heater.

### DETAILED DESCRIPTION

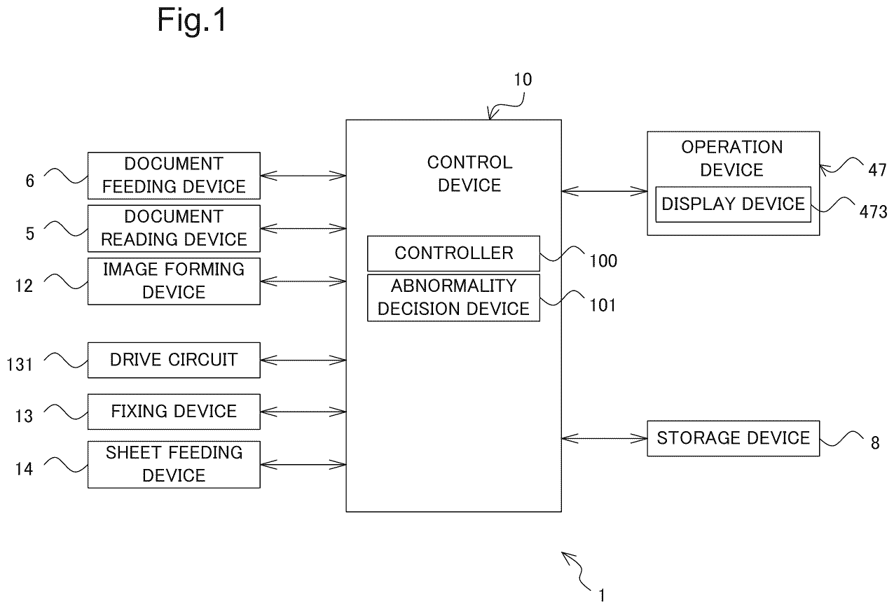

Hereafter, a fixing device and an image forming apparatus according to an embodiment of the disclosure will be described, with reference to the drawings. FIG. 1 is a functional block diagram schematically showing an essential internal configuration of the image forming apparatus according to the embodiment of the disclosure. The image forming apparatus 1 is a multifunction peripheral having a plurality of functions, such as copying, printing, scanning, and facsimile transmission.

The image forming apparatus 1 includes a control device 10, a document feeding device 6, a document reading device 5, an image forming device 12, a fixing device 13, a sheet feeding device 14, an operation device 47, a drive circuit 131, and a storage device 8.

The document feeding device 6 is openably connected to the upper face of the document reading device 5, for example via a hinge. The document feeding device 6 serves as a document retention cover, when the document reading device 5 reads a source document placed on the platen glass. The document feeding device 6 is configured as an automatic document feeder (ADF) including a document tray, and delivers the source documents placed thereon to the document reading device 5.

To perform the document reading operation, the image forming apparatus 1 operates as follows. The document reading device 5 optically reads the image on the source document delivered from the document feeding device 6 to the document reading device 5, or placed on the platen glass, and generates image data. The image data generated by the document reading device 5 is stored, for example, in an image memory.

To perform the image forming operation, the image forming apparatus 1 operates as follows. The image forming device 12 forms an image on a recording sheet, serving as a recording medium, and delivered from the paper feeding device 14, on the basis of the image data generated through the document reading operation, image data stored in the image memory, or image data received from a computer connected via the network.

The fixing device 13 heats and presses the recording sheet on which the toner image has been formed by the image forming device 12, to thereby fix the toner image on the sheet. The recording sheet that has undergone the fixing process is delivered to an output tray. The sheet feeding device 14 includes one or more sheet cassettes.

The drive circuit 131 controls the power supply to the heater 21, at a duty ratio determined by a controller 100.

The operation device 47 includes various hard keys, and receives instructions to execute the functions and operations that the image forming apparatus 1 is configured to perform, according to inputs made by the user through the hard keys. The operation device 47 also includes a display device 473 for displaying, for example, an operation guide for the user. The operation device 47 receives, through a touch panel provided on the display device 473, the user's instruction based on an operation (touch operation) performed by the user on the operation screen displayed on the display device 473. The display device 473 includes, for example, a liquid crystal display (LCD). The display device 473 includes the touch panel. When the user touches a button or a key displayed on the screen, the touch panel receives the instruction corresponding to the touched position.

The storage device 8 is a large-capacity storage device, such as a hard disk drive (HDD) or a solid state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes the controller 100.

The control device 10 acts as the controller 100 and an abnormality decision device 101, when the processor operates according to the control program stored in the storage device 8. Here, the controller 100 and the abnormality decision device 101 may each be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the drive circuit 131, the fixing device 13, the sheet feeding device 14, the operation device 47, and the storage device 8, and controls the operation of the mentioned components. For example, the controller 100 controls the operation of the image forming device 12 and the fixing device 13, to execute a print job.

The abnormality decision device 101 decides whether the duty ratio, adopted by the controller 100 to control the amount of power to be supplied to two sub heaters (first sub heater 212 and second sub heater 213 to be subsequently described), is an appropriate value corresponding to the transport status of the recording sheet P1 in a regular transport mode. Further, the abnormality decision device 101 detects, upon deciding that the duty ratio adopted to control the power supply amount to the two sub heaters is not the appropriate value, that the recording sheet P1 is being transported in a different transport status from the regular transport mode.

When the abnormality decision device 101 decides that the duty ratio adopted to control the power supply amount to the two sub heaters is not the appropriate value, the controller 100 executes a predetermined preventive operation for suppressing an excessive temperature increase of the heater 21.

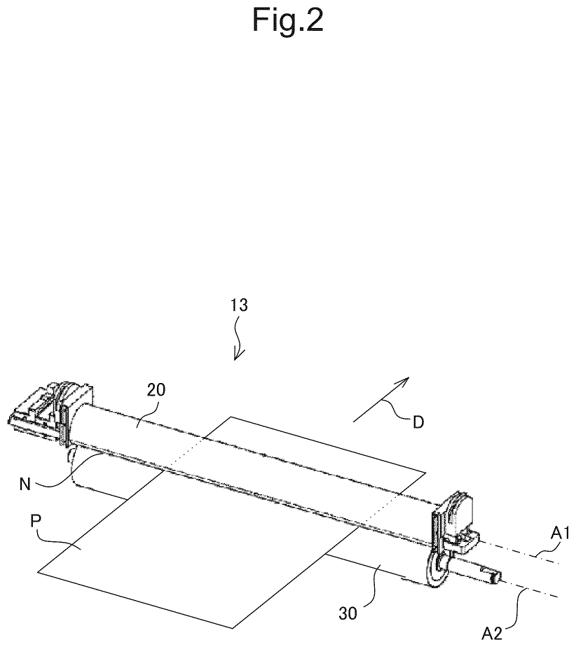

FIG. 2 is a perspective view showing an example of the fixing device 13 included in the image forming apparatus 1. The fixing device 13 includes a rotatable cylindrical fixing belt 20, and a pressure member 30. The fixing belt 20 heats the recording medium (recording sheet P), having a toner image formed thereon. The fixing belt 20 is rotatable about an axial center defined as a first rotation axis A1, and extends in the direction of the first rotation axis A1.

The pressure member 30 is a roller rotatable about an axial center defined as a second rotation axis A2 parallel to the first rotation axis A1, and extends in the direction of the second rotation axis A2. The pressure member 30 defines a nip region N, through which the recording sheet P is transported in a nipped state, between the pressure member 30 and the fixing belt 20, and drives the fixing belt 20 to rotate. An arrow D in FIG. 2 indicates the transport direction of the recording sheet P.

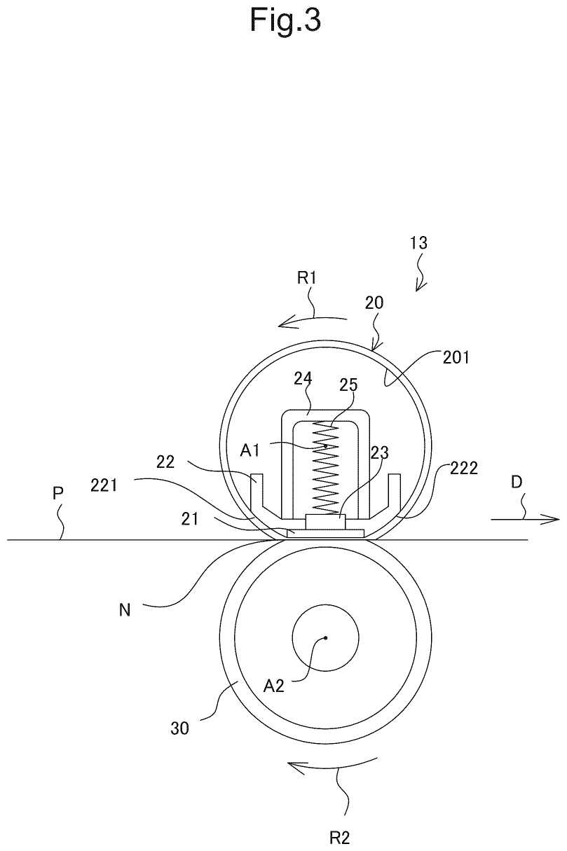

FIG. 3 is a cross-sectional view schematically showing an example of the fixing device 13. The fixing device 13 includes the fixing belt 20, the pressure member 30, a heater 21, a heater retention member 22, a temperature sensor 23, a support member 24, and a biasing member 25.

The fixing belt 20 is driven to rotate in a first rotation direction R1 (counterclockwise in FIG. 3) about the first rotation axis A1, so as to follow up the rotation of the pressure member 30 in a second rotation direction R2 (clockwise in FIG. 3) about the second rotation axis A2. The fixing belt 20 is formed in a cylindrical shape, and the circumferential surface thereof rotates in the circumferential direction.

The heater 21 heats the fixing belt 20 from inside thereof. The heater 21 is a plane heater extending in the first rotation axis A1, and located inside of the fixing belt 20 so as to oppose an inner circumferential surface 201 of the fixing belt 20. The heater 21 may be, for example, a ceramic heater including a ceramic substrate and a resistive heating element.

The heater retention member 22 retains the heater 21. The heater retention member 22 is formed of a heat-resistant resin material, in a shape having a U-shaped cross-section and extending in the direction of the first rotation axis A1. The heater retention member 22 includes opposing faces 221 and 222, respectively located on the upstream side and the downstream side in the transport direction D of the recording sheet P, and opposed to the inner circumferential surface 201 of the fixing belt 20.

The temperature sensor 23 is opposed to the heater 21, and detects the temperature of the heater 21. The temperature sensor 23 is inserted in a through hole formed in the heater retention member 22, so as to be abutted against the heater 21. The temperature sensor 23 may be, for example, a thermistor.

The support member 24 is a metal stay having an inverted U-shaped cross-section, and extending in the direction of the first rotation axis A1. The support member 24 is fixed to the main body housing of the fixing device 13. The heater retention member 22 is attached to the main body housing, so as to move toward and away from the support member 24. The support member 24 supports the posture of the heater retention member 22, when the end portion of the support member 24 on the side of the heater retention member 22 is in contact with the heater retention member 22.

The biasing member 25 is located between the temperature sensor 23 and the support member 24, and presses the temperature sensor 23 against the heater 21. The biasing member 25 may be, for example, a coil spring. Here, the mentioned configuration is merely exemplary, and the disclosure is not limited to such configuration.

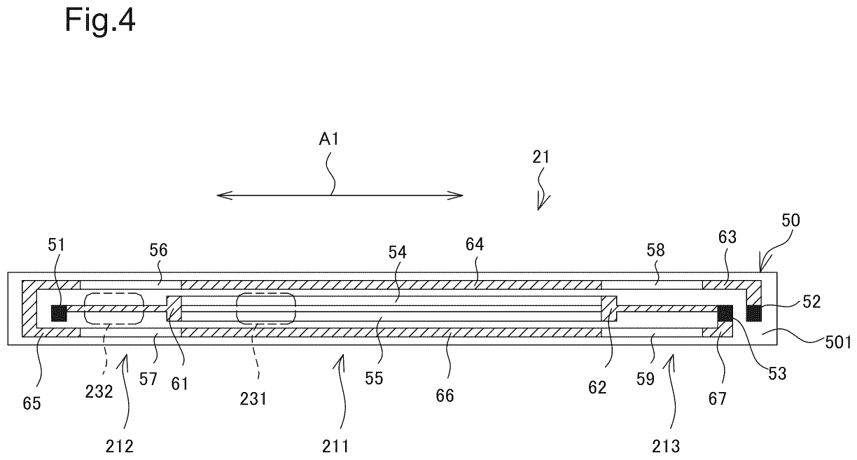

FIG. 4 is a bottom view schematically showing an example of the wiring in the heater 21. The heater 21 includes a substrate 50. The substrate 50 may be, for example, a ceramic substrate having two main faces parallel to each other, one of which is a heating surface 501.

On the heating surface 501, a first individual electrode terminal 51, a second individual electrode terminal 52, a common electrode terminal 53, a first resistive heating element 54, a second resistive heating element 55, a third resistive heating element 56, a fourth resistive heating element 57, a fifth resistive heating element 58, and a sixth resistive heating element 59 are provided. The first individual electrode terminal 51, the second individual electrode terminal 52, and the common electrode terminal 53 are connected to an electrode. For example, the first individual electrode terminal 51 and the second individual electrode terminal 52 are connected to the positive pole of the electrode, and the common electrode terminal 53 is connected to the negative pole of the electrode.

The first resistive heating element 54 and the second resistive heating element 55, constituting a main heater 211, are located in the central portion in the direction of the first rotation axis A1, and connected in parallel between the first individual electrode terminal 51 and the common electrode terminal 53. An end portion of each of the first resistive heating element 54 and the second resistive heating element 55 is connected to the first individual electrode terminal 51, via a first conductor 61. The other end portion of each of the first resistive heating element 54 and the second resistive heating element 55 is connected to the common electrode terminal 53, via a second conductor 62.

The third resistive heating element 56 and the fourth resistive heating element 57, constituting the first sub heater 212, are located at an end portion in the direction of the first rotation axis A1, and connected in series between the second individual electrode terminal 52 and the common electrode terminal 53. The fifth resistive heating element 58 and the sixth resistive heating element 59, constituting the second sub heater 213, are located at the other end portion in the direction of the first rotation axis A1, and connected in series between the second individual electrode terminal 52 and the common electrode terminal 53.

A third conductor 63 electrically connects the second individual electrode terminal 52 and the fifth resistive heating element 58, and a seventh conductor 67 electrically connects the common electrode terminal 53 and the sixth resistive heating element 59. A fourth conductor 64, a fifth conductor 65, and a sixth conductor 66 electrically connects the fifth resistive heating element 58 and the third resistive heating element 56, the third resistive heating element 56 and the fourth resistive heating element 57, and the fourth resistive heating element 57 and the sixth resistive heating element 59, respectively.

The controller 100 controls the power to be supplied to the heater 21, through a power supply circuit incorporated in the image forming apparatus 1.

The fixing device 13 includes, as shown in FIG. 3, the temperature sensor 23 that detects the temperature of the heater 21. The temperature sensor 23 includes, as shown in FIG. 4, a main temperature sensor 231 that detects the temperature of the main heater 211, and a sub temperature sensor 232 that detects the temperature of only one of the two sub heaters 212 and 213. In this embodiment, the sub temperature sensor 232 is only provided for the sub heater 212.

The main temperature sensor 231 is supported so as to oppose the main heater 211, on the side of the non-heating surface (the other main face opposite to the heating surface 501) of the substrate 50. The sub temperature sensor 232 is supported so as to oppose the first sub heater 212, on the side of the non-heating surface of the substrate 50.

The controller 100 shown in FIG. 1 controls, through the drive circuit 131, the power to be supplied to the heater 21 from the power supply circuit, on the basis of the temperature detected by the temperature sensor 23, such that the detected temperature accords with a predetermined target temperature. For example, the controller 100 determines a duty ratio corresponding to the power supplied to the heater 21, and controls the power to be supplied from the power supply circuit to the heater 21 at the duty ratio determined, through the drive circuit 131. In other words, the controller 100 controls the power supply to the heater 21 through the drive circuit 131, at the duty ratio determined as above.

To be more specific, the controller 100 controls, through the drive circuit 131, the power to be supplied to the main heater 211, at the duty ratio corresponding to the amount of power supplied to the main heater 211, determined on the basis of the temperature detected by the main temperature sensor 231. In addition, the controller 100 controls, through the drive circuit 131, the power to be supplied to both of the first sub heater 212 and the second sub heater 213, at the duty ratio corresponding to the amount of power supplied to the first sub heater 212 and the second sub heater 213, determined on the basis of the temperature detected by the sub temperature sensor 232.

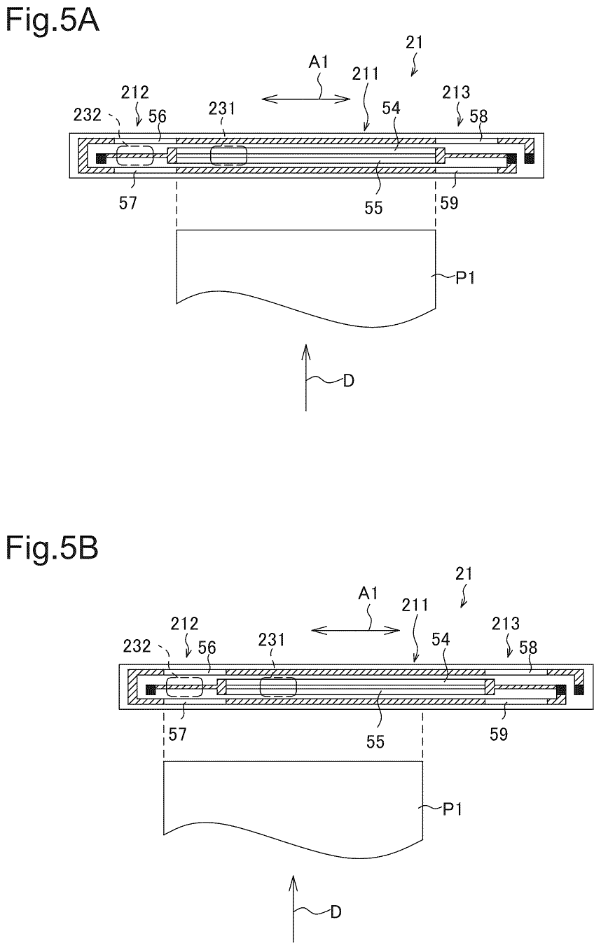

Hereunder, a one-sided transport of the recording sheet, serving as the recording medium, will be described. FIG. 5A illustrates the recording sheet P1 being transported through the correct position, in the regular transport mode. Here, it will be assumed that the size of the recording sheet P1 in the width direction (direction of the first rotation axis A1 of the fixing belt 20, orthogonal to the transport direction D) is similar to that of the main heater 211. The image forming apparatus 1 is configured such that the recording sheet P1 of this size passes the central portion in the direction of the first rotation axis A1 (where the main heater 211 is located).

In this case, the central portion in the direction of the first rotation axis A1 corresponds to the sheet passing region, through which the recording sheet P1 passes, and outer portions in the width direction (where the first sub heater 212 and the second sub heater 213 are located) each correspond to a non-passing region through which the recording sheet P1 does not pass.

The recording sheet P1 may also be transported in another mode. FIG. 5B illustrates the recording sheet P1 shifted to one side. In the case of such one-sided transport, a part of the central portion in the direction of the first rotation axis A1, and the left side in FIG. 5A and FIG. 5B (where the first sub heater 212 is located) constitute the sheet passing region through which the recording sheet P1 passes. Accordingly, the right side in FIG. 5A and FIG. 5B (where the second sub heater 213 is located) corresponds to the non-passing region through which the recording sheet P1 does not pass.

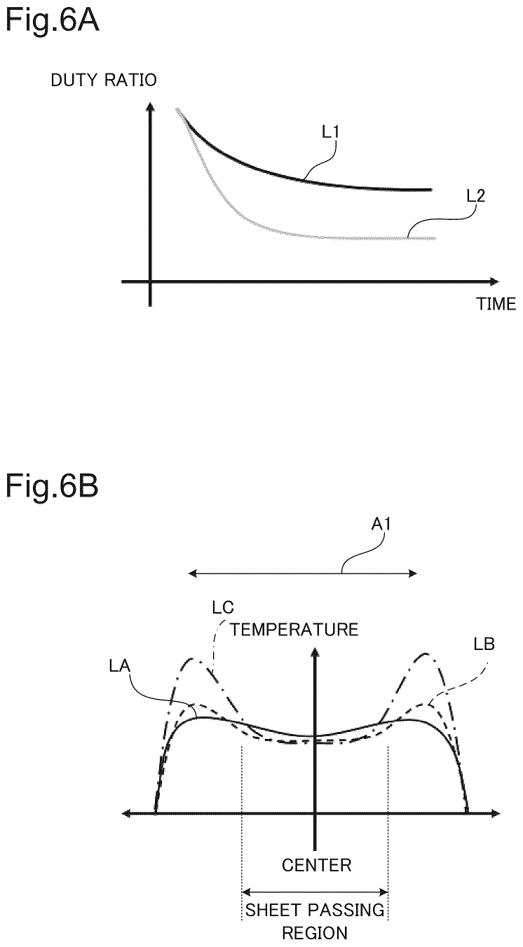

FIG. 6A is a graph showing an example of a change over time of the duty ratio of the power supplied to the heater 21 under the control of the controller 100, realized when the recording sheet P1 is being transported through the correct region as shown in FIG. 5A. A black solid line L1 represents the duty ratio of the power supplied to the main heater 211, and a gray solid line L2 represents the duty ratio of the power supplied to the first sub heater 212 and the second sub heater 213.

FIG. 6B illustrates images of temperature distribution of the heater 21 (main heater 211, first sub heater 212, and second sub heater 213), in the direction of the first rotation axis A1 (width direction of recording sheet P1), realized when the recording sheet P1 is being transported through the correct region as shown in FIG. 5A. A solid line LA represents the state before the start of a print job, and a broken line LB represents the state where, after the start of the print job, a predetermined number of recording sheets P1 have passed the fixing device 13.

Since the end portions in the direction of the first rotation axis A1 correspond to the non-passing region through which the recording sheet P1 does not pass, the heat of the first sub heater 212 and the second sub heater 213 is not taken up by the recording sheet P1, despite the recording sheet P1 passing through the fixing device 13. Accordingly, when the execution of the print job is started, the temperature detected by the sub temperature sensor 232 becomes higher than the temperature detected by the main temperature sensor 231.

Therefore, it is unnecessary to increase the duty ratio of the power supplied to the first sub heater 212 and the second sub heater 213 and, as shown in FIG. 6A, first sub heater 212 and the duty ratio of the power supplied to the second sub heater 213 (solid line L2) is set to be lower than the duty ratio of the power supplied to the main heater 211 (solid line L1), by the controller 100. As result of such control of the power supplied to the heater 21 (main heater 211, first sub heater 212 and second sub heater 213), at the duty ratio shown in FIG. 6A, the temperature distribution of the heater 21 in the direction of the first rotation axis A1 becomes as represented by the broken line LB shown in FIG. 6B.

If the duty ratio of the power supplied to the first sub heater 212 and the second sub heater 213 were set to a similar level to the duty ratio of the power supplied to the main heater 211, the temperature in the non-passing region would largely increase, and the of the heater 21 in the direction of the first rotation axis A1 would become as represented by a dash-dot line LC shown in FIG. 6B. In other words, the temperature of the first sub heater 212 and the second sub heater 213 would excessively rise.

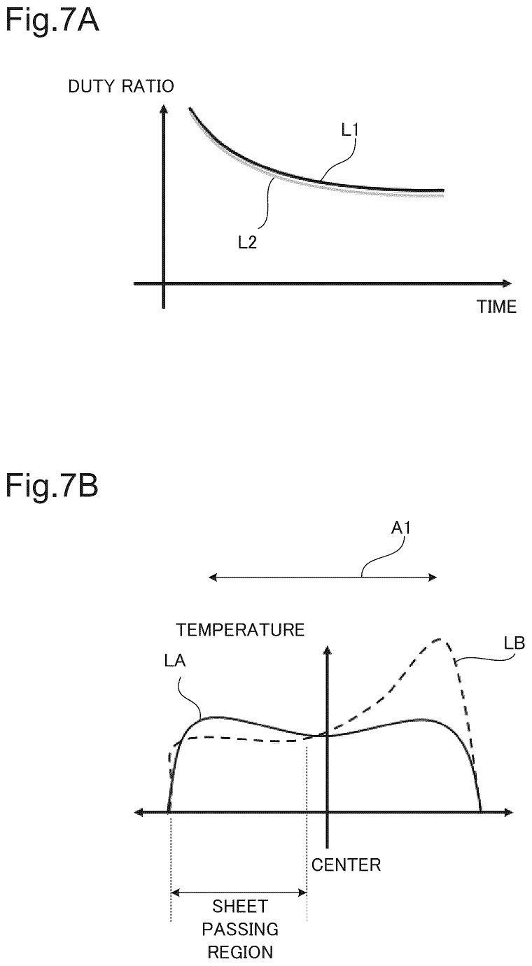

FIG. 7A is a graph showing another example of the change over time of the duty ratio of the power supplied to the heater 21, determined by the controller 100, realized when the recording sheet P1 is being transported in the shifted state as shown in FIG. 5B. The black solid line L1 represents the duty ratio of the power supplied to the main heater 211, and the gray solid line L2 represents the duty ratio of the power supplied to the first sub heater 212 and the second sub heater 213.

FIG. 7B illustrates the images of the temperature distribution of the heater 21 (main heater 211, first sub heater 212, and second sub heater 213), in the direction of the first rotation axis A1 (width direction of recording sheet P1), realized when the recording sheet P1 is being transported in the shifted state as shown in FIG. 5B. The solid line LA represents the state before the start of the print job, and the broken line LB represents the state after the print job is started, and a predetermined number of recording sheets P1 have passed the fixing device 13.

Since a part of the central portion in the direction of the first rotation axis A1 (where the main heater 211 is located), and the left side in FIG. 5B (where the first sub heater 212 is located) constitute the sheet passing region through which the recording sheet P1 passes, the heat of the main heater 211 and the first sub heater 212 is taken up by the recording sheet P1, when the recording sheet P1 passes through the fixing device 13. Accordingly, when the execution of the print job is started, the temperature detected by the sub temperature sensor 232 becomes similar to the temperature detected by the main temperature sensor 231.

Therefore, the duty ratio of the power supplied to the first sub heater 212 and the second sub heater 213 (solid line L2) is set to be similar to the duty ratio of the power supplied to the main heater 211 (solid line L1), by the controller 100.

However, since the right side in FIG. 5B in the direction of the first rotation axis A1 (where the second sub heater 213 is located) is the non-passing region through which the recording sheet P1 does not pass, it is unnecessary to set the duty ratio of the power supplied to the second sub heater 213 to a higher level. However, the controller 100 is configured to commonly control the first sub heater 212 and the second sub heater 213 in the same manner, and not to increase or decrease the duty ratio for either of the sub heaters.

When the duty ratio of the power supplied to the first sub heater 212 and the second sub heater 213 (solid line L2) is set to the similar level to the duty ratio of the power supplied to the main heater 211 (solid line L1) as shown in FIG. 7A, the temperature in the non-passing region is largely increased, and the temperature distribution of the heater 21 in the direction of the first rotation axis A1 become as represented by the broken line LB shown in FIG. 7B. In other words, the temperature of the second sub heater 213 excessively rises.

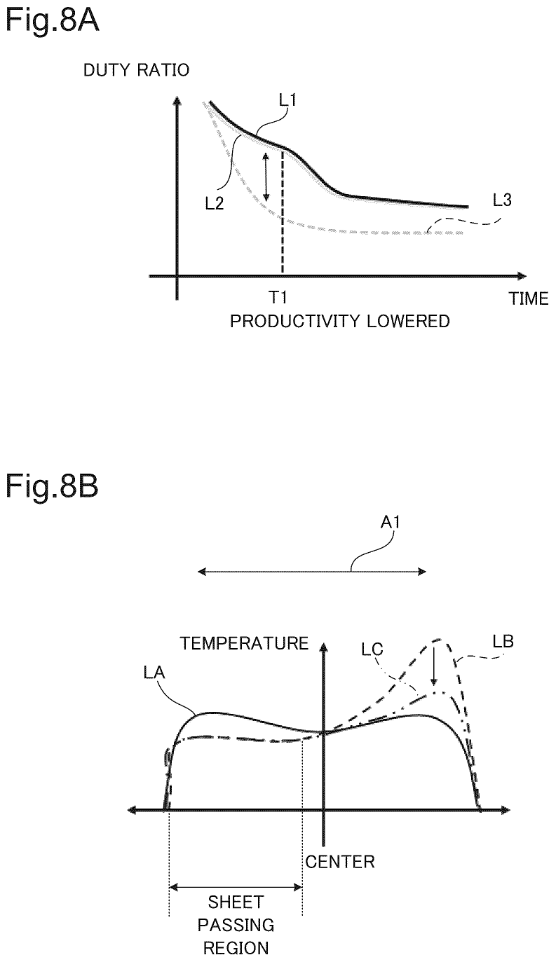

FIG. 8A is a graph showing still another example of the change over time of the duty ratio of the power supplied to the heater 21, determined by the controller 100, realized when the recording sheet P1 is being transported in the shifted state as shown in FIG. 5B. The black solid line L1 represents the duty ratio of the power supplied to the main heater 211, and the gray solid line L2 represents the duty ratio of the power supplied to the first sub heater 212 and the second sub heater 213.

FIG. 8B illustrates the images of the temperature distribution of the heater 21 (main heater 211, first sub heater 212, and second sub heater 213), in the direction of the first rotation axis A1 (width direction of recording sheet P1), realized when the recording sheet P1 is being transported in the shifted state as shown in FIG. 5B. The solid line LA represents the state before the start of the print job, and the broken line LB represents the state after the print job is started, and a predetermined number of recording sheets P1 have passed the fixing device 13.

When the recording sheet P1 is transported through the correct position in the regular transport mode (see FIG. 5A), the controller 100 controls the duty ratio of the power supplied to the first sub heater 212 and the second sub heater 213, so as to change as represented by the gray solid line L2 shown in FIG. 6A with the lapse of time, on the basis of the temperature detected by the sub temperature sensor 232. In this case, the duty ratio of the power supplied to the first sub heater 212 and the second sub heater 213 becomes lower than the duty ratio of the power supplied to the main heater 211.

However, when the recording sheet P1 is being transported in the shifted state as shown in FIG. 5B, the detection result of the sub temperature sensor 232 represents the temperature of the region where the heat of the heater is taken up by the recording sheet P1 passing therethrough. Therefore, when the controller 100 controls the power to the first sub heater 212 and the second sub heater 213, on the basis of the temperature detected by the sub temperature sensor 232, the duty ratio of the power supplied to the first sub heater 212 and the second sub heater 213 is kept from being decreased.

Accordingly, in the case where the controller 100 is controlling the duty ratio for the first sub heater 212 and the second sub heater 213, as represented by the gray solid line L2 shown in FIG. 7A, despite that the instruction to transport the recording sheet P through the correct position in the regular transport mode (see FIG. 5A) has been inputted through the operation device 47, the temperature of the second sub heater 213 excessively rises, resulting in occurrence of abnormality in the transport status.

Therefore, when the controller 100 is controlling the duty ratio for the first sub heater 212 and the second sub heater 213, as represented by the gray solid line L2 shown in FIG. 7A, despite that the instruction to transport the recording sheet P through the correct position in the regular transport mode (see FIG. 5A) has been inputted through the operation device 47, in other words when the abnormality decision device 101 decides that the duty ratio for controlling the power supplied to the first sub heater 212 and the second sub heater 213 discords with the appropriate value corresponding to the transport status of the recording sheet P1 in the regular transport mode, the abnormality decision device 101 detects that the recording sheet P1 passing through the fixing device 13 is being transported in a state different from the state in the regular transport mode, in other words that abnormality has occurred in the transport status of the recording sheet P1. In the example according to this embodiment, the abnormality decision device 101 detects that the recording sheet P1 is being transported in the shifted state (an example of abnormal transport status).

When the abnormality decision device 101 detects the abnormality in the transport status of the recording medium, the controller 100 executes the predetermined operation, to suppress the excessive temperature increase of the heater 21. The predetermined operation includes, for example, reducing the number of recording sheets P1, on which images are to be formed by the image forming device 12 per unit time, to a predetermined value (lowering the productivity). The predetermined value refers to such a number that restricts the temperature of the second sub heater 213 from reaching a temperature defined as excessively increased temperature, despite controlling the duty ratio for the first sub heater 212 and the second sub heater 213 as represented by the gray solid line L2 shown in FIG. 7A, during the image forming and fixing operation in the one-sided transport status. For example, when the standard printing speed (number of sheets printed) is 60 sheets/min., the printing speed is reduced to 20 sheets/min., which is a third of the standard speed. Such value is determined in advance, through experimental measurements.

When the productivity is lowered as above, the amount of the heat of the heater 21 taken up by the recording sheet P1 is reduced, and therefore the temperature detected by the main temperature sensor 231 and the sub temperature sensor 232 rises. For example, when the controller 100 lowers the productivity at a time point T1 after the start of the print job, the temperature detected by the main temperature sensor 231 and the sub temperature sensor 232 starts to rise as from the time point T1. Therefore, through the control based on the temperature detected by the main temperature sensor 231 and the sub temperature sensor 232, the controller 100 starts to reduce, from the time point T1, the duty ratio of the power supplied to the main heater 211 (solid line L1), and the duty ratio of the power supplied to the first sub heater 212 and the second sub heater 213 (solid line L2) as shown in FIG. 8A. Accordingly, the temperature distribution of the heater 21 in the direction of the first rotation axis A1 is changed, for example, from the broken line LB to a dash-dot-dot line LC shown in FIG. 8B. Thus, the excessive temperature increase of the fixing device 13 can be suppressed. Here, a broken line L3 represents the change over time of the duty ratio of the power supplied to the first sub heater 212 and the second sub heater 213, realized when the recording sheet P1 is transported through the correct position in the regular transport mode.

When the recording sheet P1 is of a large size that covers the entire region of the main heater 211, the first sub heater 212, and the second sub heater 213 in the width direction, the controller 100 is supposed to control the power to be supplied to the heater 21 at the duty ratio shown in FIG. 7A, when the recording sheet P1 is transported. Accordingly, the abnormality decision device 101 may decide that, when the controller 100 is controlling the duty ratio for the heater 21 as shown in FIG. 6A, despite that the larger size of the recording sheet P1 is designated by an instruction inputted to the operation device 47, the recording sheet of a size different from the designated size is being transported. In other words, the abnormality decision device 101 may further decide whether the duty ratio of the power supplied to the two sub heaters 212 and 213 accords with the appropriate value corresponding to the recording sheet P1 designated by the instruction inputted to the operation device 47. When the abnormality decision device 101 decides that the duty ratio discords with the appropriate value, the controller 100 executes the predetermined preventive operation for suppressing the excessive temperature increase of the heater 21.

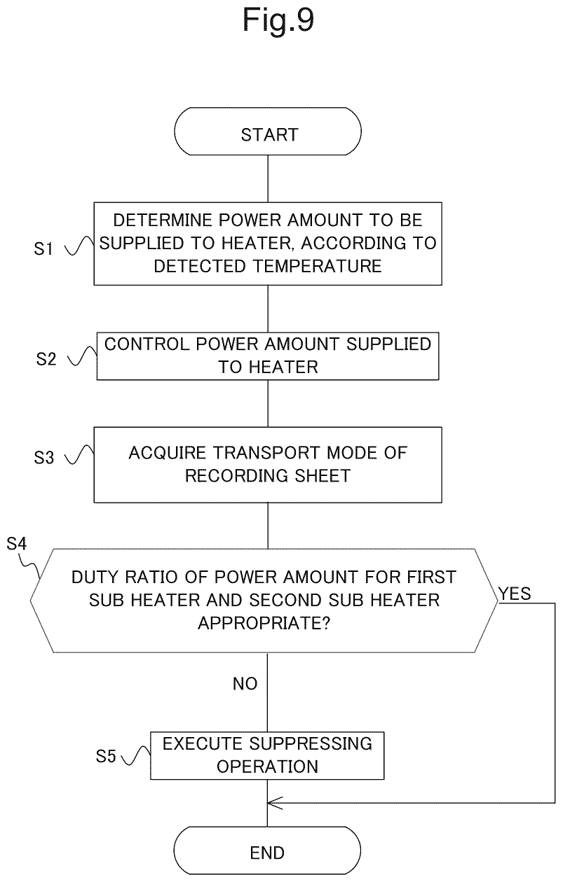

Referring now to the flowchart shown in FIG. 9, an exemplary temperature control operation of the fixing device 13, performed by the image forming apparatus 1, will be described hereunder. This control operation is performed, when the controller 100 acquires the information indicating the temperature of the main heater 211 or the first sub heater 212, outputted from the main temperature sensor 231 or the sub temperature sensor 232 of the fixing device 13.

The controller 100 determines the amount of power to be supplied to the main heater 211, and to the first sub heater 212 and the second sub heater 213, on the basis of the detected temperature indicated by the information acquired (S1). The controller 100 then controls the power supplied to each of the main heater 211, the first sub heater 212, and the second sub heater 213, as determined (S2).

The abnormality decision device 101 acquires the transport mode of the recording sheet P1, indicated by the instruction inputted through the operation device 47 (S3). The abnormality decision device 101 decides whether the acquired transport mode indicates that the recording sheet P1 is to be transported through the correct position in the regular transport mode (see FIG. 5A), and whether the duty ratio of the power supplied to the first sub heater 212 and the second sub heater 213 under the control of the controller 100 accords with the appropriate value (S4). The appropriate value refers to, for example, a duty ratio that falls in a predetermined range from the duty ratio represented by the gray solid line L2 shown in FIG. 6A.

When the abnormality decision device 101 decides that the duty ratio of the power supplied to the first sub heater 212 and the second sub heater 213, under the control of the controller 100, discords with the appropriate value (NO at S4), the controller 100 reduces the number of recording sheets P1 to be printed by the image forming device 12 per unit time to a predetermined number of sheets, as the predetermined operation (S5). Thereafter, the control operation is finished.

In contrast, when the abnormality decision device 101 decides that the duty ratio of the power supplied to the first sub heater 212 and the second sub heater 213, based on the control of the controller 100, accords with the appropriate value (YES at S4), the process of S5 is skipped, and the control operation is finished.

Now, when the size of the recording medium passing through the fixing device is relatively small, the central portion of the fixing belt in the rotation axis direction (orthogonal to the transport direction of the recording medium) constitutes the sheet passing region through which the recording medium passes, while the outer portions of such central portion each constitute the non-passing region through which the recording medium does not pass, in the nip region of the fixing device.

When the recording medium passes through the fixing device, the heat of the fixing device is taken up by the recording medium. Accordingly, when the recording medium of a small size passes through the fixing device, a large difference in temperature is created between the central portion (sheet passing region) where the heat is taken up by the recording medium and the end portions (non-passing region) where the heat is barely taken up, and the temperature may excessively rise, in the end portions of the fixing device.

Accordingly, a fixing device is known that includes a plurality of heaters that heat the fixing belt, located at different positions in the rotation axis direction of the fixing belt, to individually control the heaters to thereby suppress the temperature increase in the non-passing region (end portions) through which the recording medium does not pass. The recording medium being transported may be shifted to either side in the width direction, from the correct position in the regular transport mode, for example because of a mechanical condition of the image forming apparatus, or an inappropriate action in a manual sheet feeding operation. When the recording medium passes through the fixing device in such a shifted state, the temperature of the non-passing region may excessively rise.

Providing the temperature sensors to all the heating regions of the respective heaters, and monitoring the temperature of each of the heating regions enables the region where the temperature is excessively increasing owing to one-sided transport to be identified, thereby suppressing the excessive temperature increase. However, providing the temperature sensors to all the heating regions of the respective heaters leads to an increase in number of parts and therefore the cost, and to complication of the structure.

In addition, as another example of the inappropriate sheet feeding operation, the user may erroneously feed the recording medium of a size different from the designated size. In such a case also, the temperature may excessively rise, in the non-passing region through which the recording medium does not pass.

With the arrangement according to the foregoing embodiment, in contrast, the abnormal transport status of the recording medium passing through the fixing device 13, which provokes the excessive temperature increase of the heater 21, can be detected, despite that the sub temperature sensor 232 is provided only for one of the two sub heaters 212 and 213 (in this embodiment, only for the sub heater 212). For example, the state where the recording sheet P1 is being transported in the shifted state, despite that the recording sheet P1 is supposed to be transported through the correct position in the regular transport mode (see FIG. 5A), can be detected.

In addition, when the abnormal transport status of the recording medium passing through the fixing device 13 is detected, the preventive operation for suppressing the excessive temperature increase of the heater 21 is executed, and therefore the occurrence of the excessive temperature increase of the fixing device 13 can be suppressed. Further, since there is no need to provide the temperature sensors 23 for each of the individual heaters 21 (main heater 211, first sub heater 212, and second sub heater 213), the occurrence of the excessive temperature increase of the fixing device 13 can be prevented, with a simple structure with a reduced number of parts.

According to the foregoing embodiment, the controller 100 is configured to lower the productivity, to suppress the excessive temperature increase of the heater 21. However, as another embodiment, the controller 100 control the image forming device 12, so as to suspend the execution of the print job for forming an image.

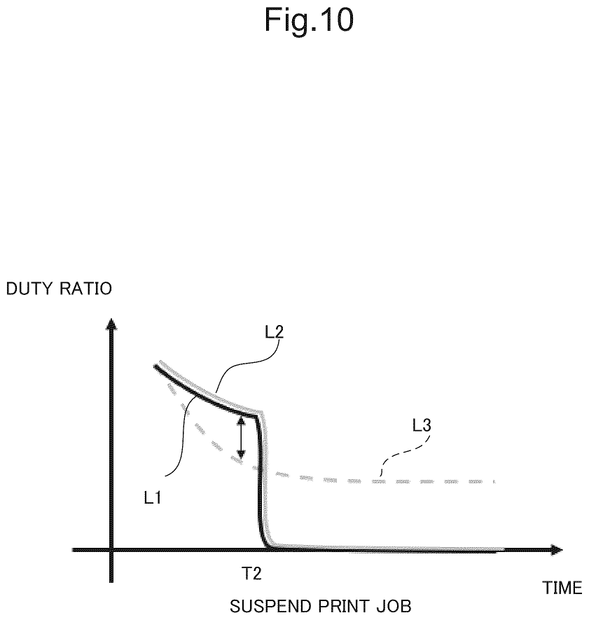

In the case where the controller 100 suspends the execution of the print job, when a time T2 has elapsed after the start of the print job as shown in FIG. 10, the duty ratio of the power supplied to the main heater 211 (black solid line L1) and the duty ratio of the power supplied to the first sub heater 212 and the second sub heater 213 (gray solid line L2) become zero, as from the time point T2. Such an operation can also suppress the excessive temperature increase of the fixing device 13. Here, the broken line L3 represents the change over time of the duty ratio of the power supplied to the first sub heater 212 and the second sub heater 213, realized when the recording sheet P1 is transported through the correct position in the regular transport mode.

The disclosure may be modified in various manners, without limitation to the foregoing embodiments. Further, the configurations and processings described in the foregoing embodiments with reference to FIG. 1 to FIG. 10 are merely exemplary, and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image forming device that forms an image on a recording medium;
a rotatable fixing belt having a cylindrical shape;
a heater that heats the fixing belt;
a pressure member that holds the fixing belt between the pressure member and the heater, thereby defining a nip region, through which the recording medium having the image formed thereon by the image forming device is transported in a nipped state, between the pressure member and the fixing belt, and drives the fixing belt to rotate; and
a drive device that activates the heater,
wherein the heater includes a main heater located at a central portion of the fixing belt in a rotation axis direction, and two sub heaters located at respective end portions,
the image forming apparatus further comprising:
a main temperature sensor that detects a temperature of the main heater;
a sub temperature sensor that detects a temperature of only one of the two sub heaters; and
a control device including a processor, and configured to act, when the processor executes a control program, as:
a controller that determines an amount of power to be supplied to the main heater, on a basis of the temperature detected by the main temperature sensor, supplies the power to the main heater through the drive device, at a duty ratio corresponding to the power amount determined, determines an amount of power to be supplied to the two sub heaters on a basis of the temperature detected by the sub temperature sensor, and supplies the power to the two sub heaters through the drive device, at a duty ratio corresponding to the power amount determined; and
an abnormality decision device that decides whether the duty ratio adopted by the controller, to control the amount of power to be supplied to the two sub heaters, accords with a first appropriate value corresponding to a transport status of the recording medium in a regular transport mode,
wherein the controller executes, when the abnormality decision device decides that the duty ratio adopted to control the amount of power to be supplied to the two sub heaters discords with the first appropriate value, a predetermined preventive operation for suppressing an excessive temperature increase of the heater.

2. The image forming apparatus according to claim 1,
wherein, upon deciding that the duty ratio adopted to control the amount of power to be supplied to the two sub heaters discords with the first appropriate value, the abnormality decision device detects that the recording medium is being transported in a status different from the transport status in the regular transport mode.

3. The image forming apparatus according to claim 1,
wherein the controller reduces, as the predetermined preventive operation, a number of sheets of the recording medium on which the image forming device forms an image per unit time, to a predetermined number of sheets.

4. The image forming apparatus according to claim 1,
wherein the controller suspends, as the predetermined preventive operation, execution of the print job including causing the image forming device to form an image.

5. The image forming apparatus according to claim 1, further comprising an operation device to which an instruction of a user is inputted,
wherein the abnormality decision device further decides whether the duty ratio adopted to control the amount of power to be supplied to the two sub heaters accords with a second appropriate value corresponding to a size of the recording medium indicated by an instruction inputted to the operation device, and
the controller executes the predetermined preventive operation for suppressing an excessive temperature increase of the heater, when the abnormality decision device decides that the duty ratio discords with the second appropriate value.
